(19) United States
(12) Patent Application Publication
(10) Pub. No.: US 2020/0260531 A1
(43) Pub. Date: Aug. 13, 2020

(54) INFRARED RADIATOR

(71) Applicant: HERAEUS NOBLELIGHT GMBH, Henau (DE)

(72) Inventors: Lotta Gaab, Darmstadt (DE); Thomas Piela, Hanau (DE); Christoph Sternkiker, Hanau (DE); Jürgen Weber, Kleinostheim (DE)

(21) Appl. No.: 16/486,431

(22) PCT Filed: Oct. 11, 2017
(86) PCT No.: PCT/EP2017/075879

§ 371 Date: Aug. 15, 2019

(30) Foreign Application Priority Data
Oct. 27, 2016 (DE) 10 2016 120 536.2

(51) Int. Cl. H05B 3/26

(52) U.S. Cl. CPC H05B 3/265; H05B 2203/016; H05B 2203/013; H05B 2203/032

(57) ABSTRACT

Known infrared radiators have a support, a heating conductor's conductor path applied to the support, of an electrically conducting resistor material, as well as an electrical contacting of the heating conductor's conductor path. In order to specify an infrared radiator with a high radiation efficiency based on this, the heating conductor's conductor path of which is provided with a structurally simple and cost-efficient electrical contacting, it is proposed according to the invention for the support to include a composite material, which comprises an amorphous matrix component as well as an additional component in the form of a semiconductor material, and for the contacting to be applied to the support as contacting conductor path, wherein the cross section of the contacting conductor path is at least 3-times the cross section of the heating conductor's conductor path.

### TECHNICAL BACKGROUND

The invention at hand relates to an infrared radiator, having a support, a heating conductor conductor path applied to the support, of an electrically conducting resistor material, as well as an electrical contacting of the heating conductor conductor path.

Infrared radiators in terms of the invention have a three-dimensional support, which can be heated by means of a resistor heating element, which is applied to the support, in the form of a heating conductor conductor path. The heating conductor's conductor path is thereby in direct contact with the support, so that the heat transfer from the heating conductor conductor path to the support occurs predominantly by heat conduction and/or convection.

Due to their design, infrared radiators according to the invention have a good performance efficiency and are used in particular for thermal heating processes, for example for the thermal treatment of semiconductor disks in the semiconductor or photovoltaic industry, in the printing industry or in the plastic processing. For example, infrared radiators according to the invention are used in the case of the polymerization of plastics, in the case of the hardening of varnishes or in the case of the drying of paints. They can moreover be used in a plurality of drying processes, for example in the case of the production of films or yarns or the manufacturing of models, samples, prototypes, tools or end products (Additive Manufacturing).

### PRIOR ART

Infrared radiators comprising different designs are used for thermal heating processes. For example, infrared radiators are known, in the case of which the heating element is arranged inside a cylindrical emitter tube, wherein emitter tube and heating element are spaced apart from one another. The heating element of these infrared radiators mostly consists of tungsten or carbon, the emitter tube is mostly made of fused silica. In the case of these radiators, a heat transfer from the heating element to the emitter tube takes place predominantly by means of thermal radiation.

Moreover, infrared radiators are known, in the case of which a metallic heating conductor is applied to a support or is embedded in support layers. In the case of these infrared radiators, the heating conductor is heated by applying an electrical voltage to the heating conductor, wherein the heat generated by the conductor is transferred to the support. Due to the direct contact of the heating conductor with the support, the heat transfer takes place predominantly by heat conduction and convection. It turned out that infrared radiators comprising a heating conductor, which is applied to a support, have a good performance efficiency.

An infrared radiator, in the case of which a metallic heating conductor is embedded between ceramic insulating layers, is known for example from DE 43 38 539 A1. In response to the production, the ceramic insulating layers are provided as green films, for example in the form of films of aluminum oxide, aluminum nitride, zirconium oxide, silicon dioxide or titanium nitride, and a metallization paste is subsequently applied thereon. Finally, a plurality of films are stacked on top of one another, are pressed and sintered. In order to provide for an electrical contacting of the heating conductor on the surface thereof, the exterior films are provided with through-contacts (vias), which, in turn, are in electrical contact with a contact surface, which is applied to the outside of the film.

Such infrared radiators, however, have the disadvantage that the electrical contacting thereof is only possible extensively via exterior contacts and through-contacts. They have a complicated setup and the production thereof is extensive.

Moreover, infrared radiators of this design are routinely only designed for power densities of around 80 kW/m². The infrared radiators of the type SHTS/100 by Elstein-Werk M. Steinmetz GmbH & Co. KG are mentioned as example for this, in the case of which a separate component is attached to the support, which is provided with the conductor path, in order to provide for an electrical contacting of the support.

If infrared radiators are used for thermal heating processes, radiators with high power densities, preferably of above 180 kW/m², are desirable on principle. On the one hand, infrared radiators with a high power density provide for a quick heating process and thus have significant influence on the irradiation time, with which a product to be heated needs to be irradiated. On the other hand, the number of the infrared radiators, which are used for irradiating a product to be heated, can be reduced in response to the use of infrared radiators having a high power density, without impacting the irradiation result. On principle, a smaller number of infrared radiators is associated with a lower maintenance effort and leads to lower production costs.

### Technical Object

The invention at hand is thus based on the technical object of specifying an infrared radiator with a high radiation efficiency, the heating conductor conductor path of which is provided with an electrical contacting of a simple and cost-efficient construction.

### GENERAL DESCRIPTION OF THE INVENTION

Based on an infrared radiator of the above-mentioned species, the above-mentioned object is solved according to the invention in that the support includes a composite material, which comprises an amorphous matrix component as well as an additional component in the form of a semiconductor material, and that the contacting is applied to the support as contacting conductor path, wherein the conductor cross section of the contacting conductor path is at least 3-times the conductor cross section of the heating conductor conductor path.

The infrared radiator according to the invention differs from the common infrared radiators in two aspects, namely on the one hand in the chemical composition of at least a portion of the support and, on the other hand, in the type of the electrical contacting, which is applied to the support and which contributes to a compact infrared radiator in this way.

The invention at hand is thereby based on the knowledge that an infrared radiator comprising a particularly high power density can be obtained, when the support is made of a thermally excitable material with a high emissivity. According to the invention, the support is thus at least partially made of a composite material, which, in addition to an amorphous matrix component, includes an additional component in the form of a semiconductor material. In the case of such a support, the physical properties thereof are also determined by the additional component. It turned out that a support, which—provided that it is heated sufficiently—can assume an energy-rich, excited state by adding a semiconductor material, in that it emits infrared radiation with a high power density, by adding a semiconductor material. Such a material is characterized by an excitation temperature, which needs to at least be reached in order to obtain the thermal excitation of the material and thus a high radiation emission. Power densities above 180 kW/m², preferably a power density in the range of between 180 kW/m² and 265 kW/m², can be reached with such an infrared radiator.

The composite material thereby comprises the following components:
With respect to weight and volume, the amorphous matrix component presents the largest portion of the composite material. It significantly determines the mechanical and chemical properties of the composite material; for example the temperature resistance, stability and corrosion properties thereof. Due to the fact that the matrix component is amorphous—it preferably consists of glass—the geometric shape of the support, compared to a support of crystalline materials, can be adapted to the demands in the case of the specific use of the infrared surface radiator according to the invention more easily.
The matrix component can consist of undoped or doped fused silica and, in addition to SiO₂ in a quantity of up to maximally 10% by weight, can include other oxidic, nitridic or carbidic components, if applicable. However, an embodiment of the infrared radiator, in the case of which the amorphous matrix component is fused silica and preferably has a chemical purity of at least 99.99% of SiO₂ and a cristobalite content of maximally 1%, has particularly proven itself in order to avoid a risk of contamination coming from the support material.
According to the invention, provision is moreover made for an additional component in the form of a semiconductor material to be embedded in the matrix component. It forms its own amorphous or crystalline phase, which is dispersed into the amorphous matrix component. It contributes to a high emissivity, so that a support is obtained, which is suitable to emit infrared radiation with a high radiation efficiency and power density.
The additional component significantly determines the optical and thermal properties of the support; more precisely, it effects an absorption in the infrared spectral range, namely the wavelength range of between 780 nm and 1 mm. The additional component shows an absorption, which is higher than that of the matrix component, for at least a portion of the radiation in this spectral range.
The phase ranges of the additional component act as optical imperfections in the matrix and have the result, for example, that the composite material—depending on the layer thickness—can visually appear black or grayish-black, at room temperature. The imperfections themselves also have a heat-absorbing effect.

In the case of the infrared radiator according to the invention, the conductor path, which is applied to the support, serves directly to heat the support. The conductor path acts as “local” heating element, by means of which at least a partial area of the support can be heated locally; it is dimensioned in such a way that it heats at least a portion of the support, which is made of the composite material. The portion of the support, which is made of the composite material, thereby forms the actual element, which emits infrared radiation. The heating conductor conductor path is connected to an electrical contacting. In the following, the term “electrical contacting” identifies a component, via which the infrared radiator can be connected to a circuit. The electrical contacting can preferably be detachably connected to a circuit via the electrical contacting, for example via a plug-in, screw or clamping connection.

Due to the fact that the portion of the support, which is made of the composite material, needs to be heated to excitation temperature under operating conditions, both the support and the heating conductor conductor path routinely have operating temperatures of above 600° C. in the area of the support, which is assigned to the heating conductor conductor path (“heating range”). To provide for an electrical contacting of the infrared radiator, in particular of the heating conductor conductor path, at the level of the support, the creation of a “cold” zone, in which the electrical contacting is arranged, is thus necessary on principle. This turned out to be favorable, when the “cold” zone has a temperature in the range of between 250° C. and 500° C.

Both the composite material and the embodiment of the electrical contacting according to the invention contribute to attaining such a zone on the support.

This is so, because it turned out that, after the composite material has reached the excitation temperature, the radiation emission of the support cannot be increased significantly via a further temperature increase. To obtain a good power efficiency, it thus turned out to be favorable, when the support is heated to excitation temperature or slightly above it under operating conditions, preferably to a temperature in the range of between 1-times and 1.1-times the excitation temperature. As a result, the support only needs to be heated to excitation temperature and not excessively above it, even in response to an operation of the infrared radiator according to the invention with a high radiation efficiency, preferably above 180 kW/m². This is why the temperature differences, which appear on the support, are within in a narrow range, even in response to an operation with high radiation efficiency, and a temperature compensation of particularly high operating temperatures, which go far beyond the excitation temperature, in particular of operating temperatures of more than 1.1-times the excitation temperature, is not necessary.

Moreover, the electrical contacting of the infrared radiator according to the invention is designed such that even a lowering of the temperature to contacting temperature is made possible by means of the electrical contacting. The electrical contacting is thus embodied as contacting conductor path, the conductor cross section of which is at least 3-times the conductor cross section of the heating conductor conductor path.

In the following, the term cross section or conductor cross section identifies the cross sectional surface of a conductor path, which runs perpendicular to the current flow direction. According to Ohm's law, the heat power of the heating conductor path as well as of the contacting conductor path is a function of the electrical resistance of the heating conductor path or of the contacting conductor path. The electrical resistance of the respective conductor paths is a function of the specific resistance of the respective conductor path material, the total length of the conductor path and the cross section of the conductor path, among others. The heat power of the contacting conductor path can be reduced in that the total resistance of the contacting conductor path is reduced. According to the invention, this takes place in that the contacting conductor path has a larger cross section than the heating conductor conductor path. As a result, the contacting conductor path has a lower resistance and, associated therewith, a lower heat power than the heating conductor conductor path.

Due to the fact that the contacting conductor path is applied directly to the support, a contacting area, which differs from the part of the surface of the support, which is covered with the heating conductor conductor path, is created on the support surface. This surface is also identified as conductor path occupation surface. In particular due to the smaller heat power of the contacting conductor path, the support has a lower temperature in the contacting area. Even though it generally applies that the temperature in the contacting area decreases further as the distance to the conductor path occupation surface increases, the temperature in the contacting area is also significantly a function of the cross section of the contacting conductor path. It thus turned out that a contacting area of a low temperature can be obtained, when the conductor cross section of the contacting conductor path is at least 3-times the conductor cross section of the semiconductor conductor path. Particularly good results with regard to the temperature decrease are obtained, when the conductor cross section of the contacting conductor path is at least 6-times the conductor cross section of the heating conductor conductor path. Particularly preferably, the conductor cross section of the contacting conductor path is in the range of between 6-times and 10-times the conductor cross section of the heating conductor conductor path.

An infrared radiator according to the invention can be produced in a simple and cost-efficient manner, in that the heating conductor conductor path is applied to a surface of the support by using printing technologies, for example by means of screen printing or ink jet printing. Due to the fact that the contacting conductor path as well as the heating conductor conductor path is applied to the support, both conductor paths can be applied in a single operating step. It turned out to be favorable hereby, when the contacting conductor path and the heating conductor conductor path are located in one plane. The support thus preferably has a flat surface, which is covered with the heating conductor conductor path and the contacting conductor path.

In the case of a preferred embodiment of the infrared radiator according to the invention, the heating conductor conductor path and contacting conductor path are connected to one another with a substance-to-substance bond.

In the case of substance-to-substance bonds, the connecting partners, here thus the heating conductor conductor path and the contacting conductor path, are held together by atomic or molecular forces. Substance-to-substance bonds belong to the group of the non-detachable connections and are thus characterized by a high mechanical stability and durability. Substance-to-substance bonds are obtained for example by soldering, welding or adhesion of the heating conductor conductor path with the contacting conductor path. A substance-to-substance bond also results when the heating conductor conductor path and the contacting conductor path are applied to the support, for example in the form of metallization pastes, and when the support, which is provided with the metallization pastes, is sintered subsequently.

It turned out to be favorable, when the heating conductor conductor path and the contacting conductor path are made of the same material.

The heating conductor's conductor path and the contacting conductor path can be made of the same or chemically different metallization pastes. For example the ink jet printing provides for a simple application of chemically different metallization pastes, because the application of metallization pastes of different chemical composition can take place in one operating step in the case of said ink jet printing.

The mechanical and chemical resistance of the heating conductor's conductor path and of the contacting conductor path is a function of the materials, among others, of which the above-mentioned conductor paths are made. A connection of the conductor paths with good chemical and mechanical resistance is obtained, when the heating conductor's conductor path as well as the contacting conductor path are made of the same material.

Preferably, the contacting conductor path connects directly to the heating conductor conductor path.

According to the invention, the heating conductor's conductor path and the contacting conductor path differ in their cross section. A contacting conductor path, which directly follows the heating conductor's conductor path, is thus associated with a direct, erratic transition from the heating conductor conductor path cross section into the contacting conductor path cross section. Such a direct transition has the advantage that no transition zone is present, which is associated with a certain space requirement. A direct transition from the heating conductor's conductor path into the contacting conductor path moreover contributes to the fact that the support provides a temperature transition area, which is as small as possible, from a “heating area”, which is provided with the heating conductor's conductor path, into a “contacting area”, which is provided with the contacting conductor path. A transition zone, which is as compact as possible, and, associated therewith, a compact contacting area, is made possible in this way.

In the case of a likewise preferred embodiment of the infrared radiator according to the invention, provision is made for a transition conductor path, the conductor cross section of which, based on the conductor cross section of the heating conductor conductor path, increases continuously or in a plurality of stages, until the conductor cross section of the contacting conductor path is reached, to be arranged between heating conductor conductor path and contacting conductor path.

The type of the transition between heating conductor's conductor path and contacting conductor path has a significant impact on the temperature profile in the area of this transition. Compared to the heating conductor's conductor path, the contacting conductor path forms a “cold” zone, in which a simple connection of the contacting conductor path with a circuit is possible. A temperature gradient is thus routinely created in particular in the edge area of the “cold” zone, thus in the transition area of heating conductor conductor path into contacting conductor path. A quick transition of high temperatures into lower temperature thereby has the disadvantage that the support is subjected to high thermal stresses. Depending on the chemical composition of the support, in particular unwanted material stresses can appear in the support, which can damage the latter. Depending on the chemical characteristic of the support, it may thus be desirable to create a flatter temperature gradient in the transition area. This can take place for example in that the cross section of the heating conductor's conductor path transitions continuously or in stages into the cross section of the contacting conductor path. In the case of a transition conductor path, the cross section of which increases continuously, starting at the cross section of the heating conductor's conductor path, a continuously increasing transition resistance, which is associated with a flatter, largely continuous temperature gradient, is created due to this structure. Moreover, it is also possible for the cross section of the transition conductor path to increase in stages, starting at the cross section of the heating conductor's conductor path, thus in a plurality of stages. In this case, a simple and quick adaptation of the transition resistances of the transition conductor path is possible by means of a variation of the stage cross section and of the stage length, so that a desired temperature profile can be created by suitably selecting the transition resistances.

It turned out to be particularly favorable, when the cross section of the contacting conductor path is in the range of between 0.06 mm² and 0.2 mm², and the cross section of the heating conductor conductor path is in the range of between 0.02 mm² and 0.06 mm².

The cross section of a conductor path, also called conductor cross section, is the cross sectional surface through the conductor path, observed in current flow direction. In the case of a layer-shaped conductor path with a rectangle shape, the conductor cross section thus results from multiplication of layer width and layer thickness.

The cross sectional height of the heating conductor's conductor path and of the contacting conductor path is preferably in the range of between 10 μm and 25 μm.

The cross section of a conductor path or the cross sectional surface thereof, respectively, can be described by a cross sectional base side and a cross sectional height. The cross sectional base side is the side of the cross section, with which the conductor path adjoins the support. The cross sectional height is the maximum extension of the cross section, measured perpendicular to the base side. In the case of a layer-shaped conductor path with rectangular cross section, the cross sectional surface follows from multiplication of cross sectional base side and cross sectional height.

Even though the cross sectional height does on principle have an impact on the electrical resistance of the conductor path and thus on the temperature distribution on the support, the electrical resistance of the conductor path also depends on the further parameters, in particular the cross sectional surface and the cross sectional base side thereof. If both the heating conductor's conductor path and the contacting conductor path have a height in the above-specified range, they only have slight height differences, so that the cross sectional differences provided according to the invention between heating conductor's conductor path and contacting conductor paths must, conversely, result from cross sectional bases of the respective conductor paths, which differ from one another. It turned out to be particularly favorable in this context, when the cross sectional height of the heating conductor's conductor path and of the contacting conductor paths coincide. Coinciding cross sectional heights of the conductor paths are obtained in particular when both conductor paths are made in one operating step.

A conductor path with a cross sectional height in the range of between 10 μm and 25 μm can be manufactured easily and cost-efficiently; it can in particular be applied to the support in a single operating step, for example by means of screen printing or ink jet printing. A conductor path with a cross sectional height of less than 5 μm has only a small mechanical stability and can moreover only be manufactured extensively with a constant quality. A conductor path with a cross sectional height of more than 25 μm can only be applied extensively onto the support in one operating step.

It has proved its worth when the support is made completely of the composite material.

A support, which is made of a single material, here the composite material, can be made particularly easily and cost-efficiently. It moreover has the advantage that a large surface portion of the support surface can be occupied with the heating conductor conductor path, so that a particularly compact, highly-efficient infrared radiator is obtained.

In the case of a preferred embodiment of the infrared radiator according to the invention, the support is made completely of the composite material, wherein the composite material is an electrical insulator.

The support can be embodied in a plurality of layers and, in addition to the composite material, can also include other material areas. It turned out, however, that it is favorable for the operation of the infrared radiator, when the support surface is made of an electrically insulating material, at least in areas, in which it is provided with a conductor path. A low-interference operation of the infrared radiator is thus ensured, in particular flashovers and short-circuits between adjacent conductor path sections are prevented. If the support is made completely of the composite material, the conductor paths can be applied directly to the support.

A support made of a plurality of materials can for example have a layer structure, in which two or more material layers can be arranged on top of one another. In the alternative, it is also possible for the support to have a core of a first material, preferably the composite material, which is coated with a coating of a second material. The core can be coated completely or partially with the second material. The core is preferably partially coated with the second material.

In the case of a likewise preferred embodiment of the infrared radiator according to the invention, the composite material is coated with a layer of an electrically insulating material, at least in the areas of the support, which are occupied with the conductor paths.

The support has at least two areas, which are occupied with a conductor path, namely a first area, to which the heating conductor's conductor path is assigned, and a second area, in which the contacting conductor path is located. The support can furthermore have further areas, for example an additional heating conductor or contacting conductor path.

The composite material, of which the support is made, displays a good emissivity in the infrared range. For the use in an infrared radiator according to the invention, further physical properties of the composite material are furthermore important, in particular the electrical conductivity thereof. Whether a composite material is an electrical insulator under operating conditions or has a certain electrical conductivity mainly depends on the chemical composition of the composite material. However, an electrically conductive composite material cannot be provided directly with a conductor path, because short circuits may occur during the operation of the infrared radiator, for example. To be able to nonetheless produce a support of an electrically conductive composite material, it turned out to be favorable, when said support is initially coated with a layer of an electrically insulating material.

The composite material can be coated completely or partially with an electrically insulating material. In any event, at least the areas of the support, to which a conductor path is assigned, should be coated with a layer of an electrically insulating material, for example with a layer of glass, in particular of fused silica.

In the case of a further, likewise preferred embodiment of the infrared radiator according to the invention, provision is made for the support to have a first material area made of the composite material and a second material area, which differs from the first material area in its chemical composition, wherein the heating conductor's conductor path is applied to the first material area and the contacting conductor path is applied to the second material area.

A temperature distribution, which is particularly favorable for the electrical contacting of the infrared radiator, with a good temperature drop in the area of the contacting conductor path is obtained, when the support comprises a plurality of material areas, which differ in their chemical composition. The heating conductor's conductor path and the contacting conductor path can in particular be applied to different materials, wherein the materials are chosen in such a way that a particularly high radiation efficiency is attained on the one hand and a good temperature drop is attained in the area of the contacting conductor path on the other hand.

It has thereby proved itself, when the first material area is made of the composite material and is occupied with the heating conductor's conductor path. The heating conductor's conductor path is preferably applied only to the first material area. Due to the high emissivity of the composite material, the assignment of the heating conductor conductor path to the first material area made of the composite material provides for an infrared radiator with particularly high radiation efficiency.

Due to the fact that the contacting conductor path is attached to the second material area, the second material area of the support can be made of a material, which—compared to the composite material—has a lower emissivity. Due to its smaller emissivity, the second material area is associated with a lower heat development and thus contributes to a particularly effective temperature decrease in the contacting area of the support in addition to the enlarged cross section of the contacting conductor path. The contacting conductor path is preferably only applied to the second material area.

Provision is made in the case of a further preferred embodiment of the infrared radiator according to the invention for the percentage by weight of the additional component to be in the range between 1% and 5%, preferably in the range between 1.5% and 3.5%.

The heat absorption of the composite material is a function of the percentage of the additional component. The percentage by weight of the additional component should thus preferably be at least 1%. On the other hand, a high percentage by volume of the additional component can impact the chemical and mechanical properties of the matrix. With regard to this, the percentage by weight of the additional component is preferably in the range between 1% and 5%, preferably in the range between 1.5% and 3.5%.

It turned out to be favorable when the heating conductor's conductor path and/or the contacting conductor path are embodied as burned-in thick film layer or when they are applied as molded part to the surface of the support in such a way that the conductor paths and the support are permanently connected to one another.

The production of the heating conductor's conductor path or of the contacting conductor path, respectively, can take place by different production methods, for example using printing techniques, but also by stamping, laser beam cutting or casting. The heating conductor's conductor path and contacting conductor path can be produced as separate components or as a single component in one operating step.

It turned out to be particularly favorable when the heating conductor's conductor path and/or the contacting conductor path are embodied as burned-in thick film layer. Such thick film layers are created for example of resistor paste by means of screen printing or of metal-containing ink by means of ink jet printing and are subsequently burned in at a high temperature.

In the alternative, the heating conductor conductor path and the contacting conductor path can also be produced as molded part of a metal plate using a thermal separating method, for example by laser beam cutting or by stamping. The use of thermal separating or stamping methods provides for the production of conductor paths in large quantities and thus contributes to keeping material and production costs low.

It turned out to be favorable when the heating conductor conductor path is made of platinum, high-temperature proof steel, tantalum, a ferritic FeCrAl alloy, an austenitic CrFeNi alloy, silicon carbide, molybdenum silicide or a molybdenum base alloy.

The above-mentioned materials, in particular silicon carbide (SiC), molybdenum silicide (MoSi₂), tantalum (Ta), highly heat-resistant steel or a ferritic FeCrAl alloy, such as Kanthal® (Kanthal® is a registered trademark of SANDVIK INTELLECTUAL PROPERTY AB, 811 81 Sandviken, SE) are cost-efficient as compared to precious metals, for example gold, platinum or silver; they can be formed easily into a conductor path molded body, which can be used as semi-finished product in response to the production of the infrared radiator. They are in particular available as metal plates, from which a conductor path can be made in a simple and cost-efficient manner. The above-mentioned materials moreover have the advantage that they are oxidation-resistant in air, so that an additional layer (cover layer), which covers the conductor path, is not absolutely necessary to protect the conductor path.

In the composite material, the additional component is preferably present in a type and quantity, which effects a spectral emissivity ε of at least 0.6 in the composite material for wavelengths of between 2 μm and 8 μm at a temperature of 600° C. In the case of a particularly preferred embodiment of the infrared radiator according to the invention, the additional component is present in a type and quantity, which effects a spectral emissivity ε of at least 0.75 in the composite material for wavelengths of between 2 μm and 8 μm at a temperature of 1,000° C.

The composite material thus has a high absorptivity and emissivity for thermal radiation between 2 μm and 8 μm, thus in the wavelength range of the infrared radiation. This reduces the reflection at the support surfaces, so that a reflectivity for wavelengths of between 2 μm and 8 μm at temperatures of above 1,000° C. is maximally 0.25 and maximally 0.4 at temperatures of 600° C., assuming a negligibly small transmission. Non-reproducible heating caused by reflected thermal radiation is thus avoided, which contributes to an even or desirably uneven temperature distribution.

A particularly high emissivity can be attained, when the additional component is present as additional component phase and when it has a non-spherical morphology with maximum dimensions of less than 20 μm on average, but preferably of more than 3 μm.

The non-spherical morphology of the additional component phase thereby also contributes to a high mechanical stability and to a small tendency of the composite material to form cracks. The information “maximum dimension” refers to the longest expansion of an insulated area with additional component phase, which can be recognized in the grinding. The median value of all longest expansions in a grinding pattern forms the above-mentioned average value.

According to Kirchhoff's law of thermal radiation, spectral absorption coefficient α_{λ} and spectral emissivity ε_{λ} of an actual body correspond to one another in the thermal equilibrium.

α_{λ}=ε_{λ} (1)

The additional component thus has the result that the substrate material emits infrared radiation. In the case of known directional hemispherical spectral reflectivity R_{gh} and transmittance T_{gh}, the spectral emissivity ε_{λ} can be calculated as follows:

ε_{λ}=1−R_{gh}−T_{gh} (2)

The “spectral emissivity” is hereby understood to be the “spectral normal emissivity”. The latter is determined by means of a measuring principle, which is known under the name “Black-Body Boundary Conditions” (BBC) and which is published in “DETERMINING THE TRANSMITTANCE AND EMITTANCE OF TRANSPARENT AND SEMITRANSPARENT MATERIALS AT ELEVATED TEMPERATURES”; J. Manara, M. Keller, D. Kraus, M. Arduini-Schuster; 5th European Thermal-Sciences Conference, The Netherlands (2008).

In the composite material, thus in connection with the additional component, the amorphous matrix component has a higher thermal radiation absorption than would be the case without the additional component. This results in an improved thermal conduction from the conductor path into the substrate, in a quicker distribution of the heat and in a higher radiation rate on the substrate. It is thus possible to provide a higher radiation efficiency per unit area and to also create a homogenous radiation and a homogenous temperature field in the case of thin substrate wall thicknesses and/or in the case of a comparatively small conductor path occupation density. A substrate comprising a small wall thickness has a small thermal mass and provides for quick temperature changes. A cooling is not required for this.

### EXEMPLARY EMBODIMENT

The invention will be explained in more detail below by means of exemplary embodiments and drawings. In schematic illustration

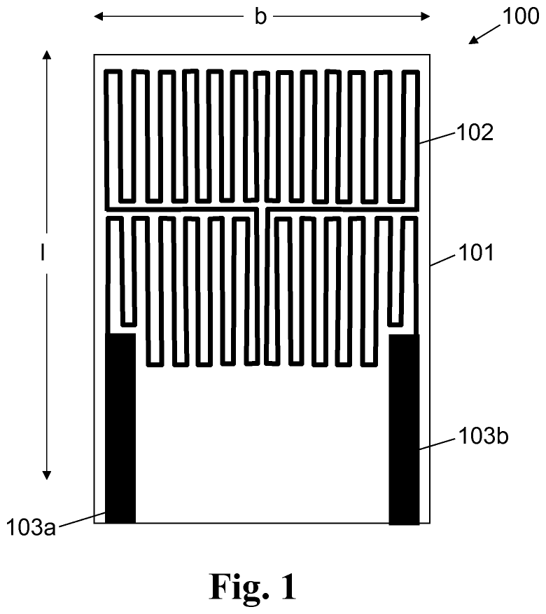

FIG. 1 shows a first embodiment of an infrared radiator according to the invention comprising a support of a composite material and a contacting conductor path applied to the support,

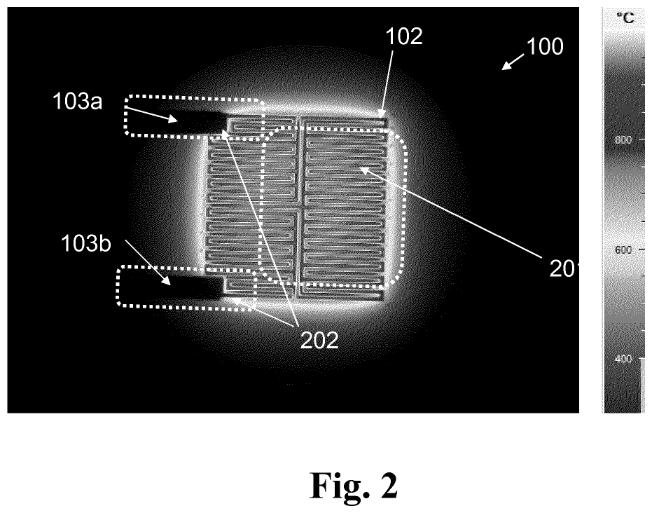

FIG. 2 shows a thermographic recording of the infrared radiator according to FIG. 1 under operating conditions,

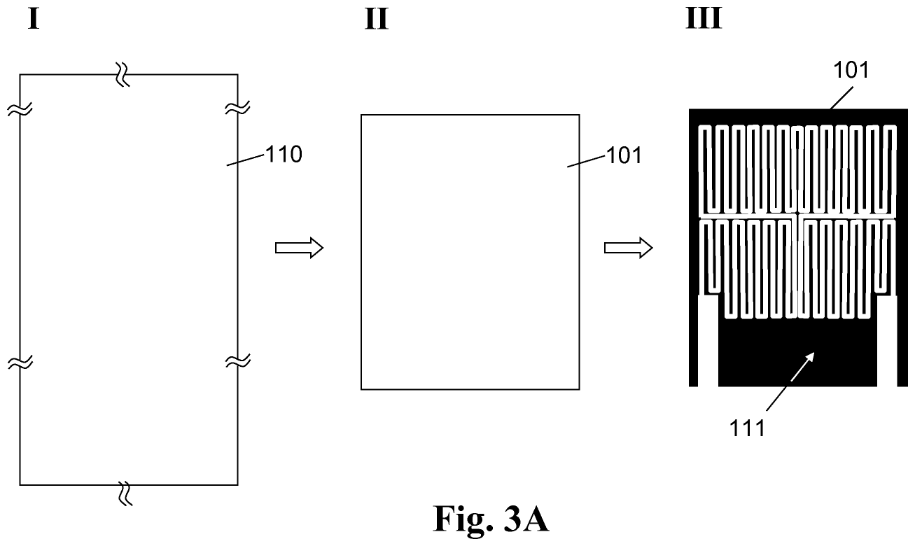

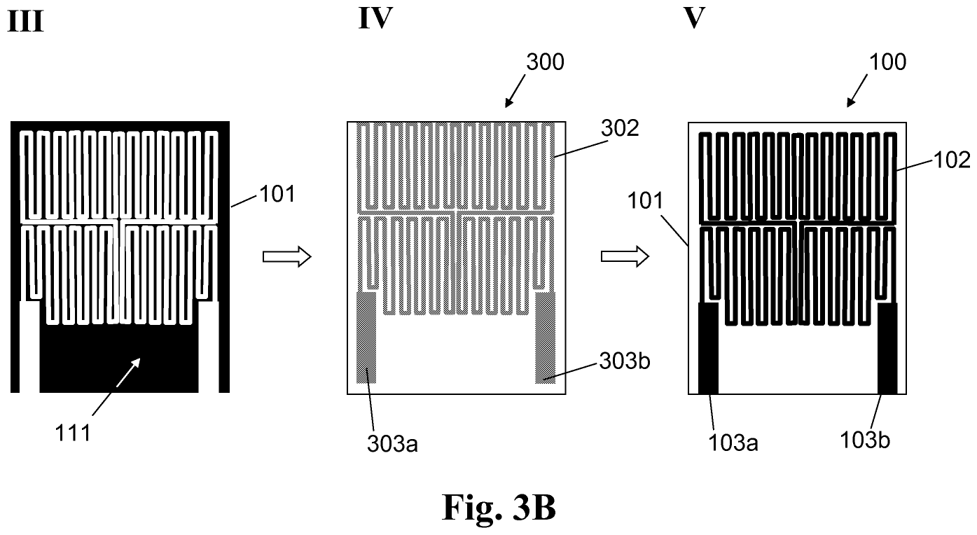

FIG. 3A shows the first part of a method for producing an infrared radiator according to the invention with methods steps I to III,

FIG. 3B shows the second part of the method for producing an infrared radiator according to the invention with method steps III to V, and

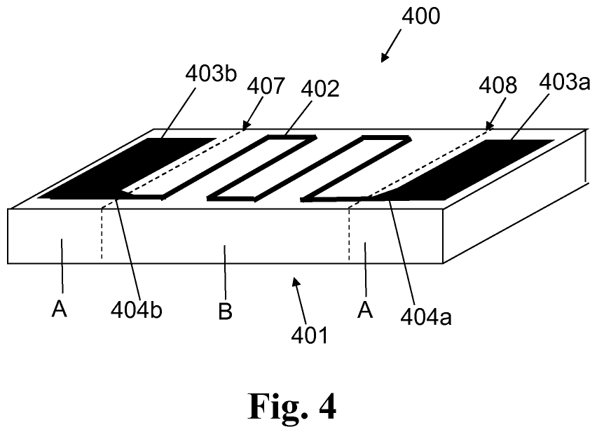

FIG. 4 shows a second embodiment of an infrared radiator according to the invention, in the case of which the support comprises two material areas, which differ in their chemical composition.

FIG. 1 shows a first embodiment of an infrared radiator according to the invention, to which as a whole reference numeral 100 is assigned. The infrared radiator 100 is designed to reach a power density of 150 kW/m² and has a plate-shaped support 101 and a heating conductor's conductor path 102, which is applied to the support 101. On its ends, the heating conductor's conductor path 102 is in each case provided with an electrical contacting in the form of contacting conductor paths 103a, 103b.

The support 101 is made completely of a composite material, which comprises an amorphous matrix component in the form of fused silica, in which a phase of elementary silicon in the form of non-spherical areas is distributed homogenously.

The support has a length l of 100 mm, a width b of 100 mm and a thickness of 2 mm.

The heating conductor's conductor path 102 and the contacting conductor paths 103a, 103b consist of platinum; they were applied to the support 101 in the form of a platinum paste in one operating step by means of screen printing and were subsequently burned in. Due to the fact that the heating conductor's conductor path 102 and the contacting conductor paths 103a, 103b were applied in one operating step, they are connected to one another by means of a substance-to-substance bond.

The contacting conductor paths 103a, 103b connect directly to the ends of the heating conductor's conductor path 102. The heating conductor's conductor path 102 has a rectangular cross section comprising a cross sectional height of 20 μm and a cross sectional base side of 1 mm. The contacting conductor paths 103a, 103b are embodied identically, they each have a rectangular cross section comprising a cross sectional height of 20 μm and a cross sectional base side of 3 mm. The cross sectional surface of the contacting conductor paths 103a, 103b is 0.06 mm² in each case. The cross sectional surface of the heating conductor's conductor path 102 is 0.02 mm². The cross section of the contacting conductor paths 103a, 103b is thus 3-times the cross section of the heating conductor conductor path 102.

Provided that the same reference numerals as in FIG. 1 are used in the case of the embodiments shown in the other figures, they identify structurally identical or equivalent components and parts, as they are explained in more detail above by means of the description of the first embodiment of the infrared radiator according to the invention.

FIG. 2 shows a thermographic recording of the infrared radiator 100 described in FIG. 1 under operating conditions. The recording was made using a thermography camera of the type INFRATEC VARIOCAM HR HEAD; it shows the temperature distribution of the support. An average temperature of approximately 1,000° C. is reached in the heating area 201 of the heating conductor's conductor path 102. In contrast to this, the temperature in the contacting area 202 is below 300° C.

A method for producing the infrared radiator 100 is explained in an exemplary manner by means of FIGS. 3A and 3B.

Method Step I—Production of a Green Body (Semi-Finished Product 1)

The production takes place by means of the slip casting method, as it is described in WO 2015/067 688 A1. First of all, amorphous fused silica grit is purified in a hot chlorination method, whereby it is ensured that the cristobalite content is below 1% by weight. Fused silica grit with grain sizes in the range between 250 μm and 650 μm is wet-ground with deionized water, so that a homogenous base slip comprising a solids content of 78% is formed.

The grinding balls are subsequently removed from the base slip and an addition in the form of silicon powder is added in a quantity, until a solids content of 83% by weight is reached. The silicon powder predominantly contains non-spherical powder particles comprising narrow particle size distribution, the D₉₇ value of which is approximately 10 μm and the fine portion of which with particle sizes of less than 2 μm has been removed beforehand.

The slip, which is filled with silicon powder, is homogenized for another 12 hours. The percentage by weight of the silicon powder of the total solids content is 5%. The SiO₂ particles in the completely homogenized slip show a particle size distribution, which is characterized by a D₅₀ value of approximately 8 μm and by the D₉₀ value of approximately 40 μm.

The slip is cast into a die of a commercial casting machine and water is removed via a porous plastic membrane by forming a porous green body 110. The green body 110 has the shape of a rectangular plate. To remove bound water, the green body is dried for 5 days at approximately 90° C. in a ventilated furnace.

Method Step II—Cutting the Green Body to Size

After the cool-down, the obtained porous green body 110 is processed mechanically virtually to the final dimensions of the fused silica support plate, which is to be produced, comprising the plate thickness of 4 mm. Said support plate is identified below as blank. To sinter the blank, the latter is heated up to a heating temperature of 1390° C. in a sintering furnace under air within 1 hour and is held at this temperature for 5 hours.

The fused silica support plate obtained in this manner forms the support 101. It consists of a gas-tight composite material comprising a density of 2.1598 g/cm³, in the case of which non-spherical areas of elementary Si phase, which are separated from one another and the size and morphology of which largely corresponds to those of the used Si powder, are distributed homogenously in a matrix of opaque fused silica. On average (median), the maximum dimensions are in the range of between approximately 1 μm and 10 μm. The matrix becomes visually translucent to transparent. By microscopic examination, it does not show any open pores and at best closed pores comprising maximum dimensions of less than 10 μm on average; the porosity calculated on the basis of the density is 0.37%. The composite material in air is stable up to a temperature of approximately 1,150° C.

Method Step III—Applying the Heating Conductor Conductor Path 102 and the Contacting Conductor Paths 103a, 103b by Means of Screen Printing

The heating conductor's conductor path 102 and the contacting conductor paths 103a, 103b are applied to the surface of the support 101 in the form of a platinum resistor paste by means of screen printing. For this purpose, a fine-meshed fabric 111 is placed onto the support 101, the mesh openings of which are made to be impermeable at the locations, at which no platinum resistor paste is to be printed. These locations are illustrated as black surface in FIG. 3A-III.

Method Step IV—Removing the Fabric 111

After the printing process has taken place and after the fabric 111 has been removed from the support 101, a support 300, which is coated with the platinum resistor paste, is obtained, onto which a blank shape 302 of the later heating conductor's conductor path 102 and a blank shape 303a, 303b of the later contacting conductor paths 103a, 103b are applied.

Method Step V—Burning in the Conductor Paths

The heating conductor's conductor path 102 and the contacting conductor paths 103a, 103b are obtained by burning in at a burn-in temperature of 1,200° C.

Applying a Reflector Layer (Optional)

The method step described below is optional and is thus not illustrated in FIGS. 3A and 3B. A slip layer is applied to the top side of the support 101 and to the conductor paths 102, 103a, 103b applied thereon. This slip is obtained by modification of the SiO₂ base slip, as is already described above (without adding silicon powder) in that amorphous SiO₂ grit in the form of spherical particles comprising a grain size of around 5 μm are added to the homogenous, stable base slip, until a solids content of 84% by weight is reached. This mixture is homogenized for 12 hours in a drum mill at a speed of 25 U/min. The slip obtained in this way has a solids content of 84% and a density of approximately 2.0 g/cm³. The SiO₂ particles in the slip obtained after the grinding of the fused silica grit display a particle size distribution, which is identified by a D₅₀ value of approximately 8 μm and by a D₉₀ value of approximately 40 μm.

The slip is sprayed onto the top side of the substrate 101, which was first purified in alcohol, for several seconds. An even slip layer comprising a thickness of approximately 2 mm is thus formed on the substrate 101. The dried slip layer is free of cracks and it has an average thickness of slightly less than 2 mm.

The dried slip layer is subsequently sintered under air in a sintering furnace.

In a perspective illustration, FIG. 4 shows a second embodiment of an infrared radiator according to the invention, to which as a whole reference numeral 400 is assigned. The infrared radiator 400 has a plate-shaped support 401, a heating conductor's conductor path 402, two contacting conductor paths 403a, 403b, as well as two transition conductor paths 404a, 404b. The infrared radiator 400 can optionally be provided with a cover layer (not illustrated), as it is described in the description of FIGS. 3A and 3B.

The plate-shaped support 401 has a rectangular shape comprising a plate thickness of 2.5 mm. The heating conductor path 402, the transition conductor paths 404a, 404b and the contacting conductor paths 403a, 403b are applied to the surface of the support 401. The heating conductor's conductor path 402 has a rectangular cross section comprising a cross sectional surface of 0.04 mm² with a cross sectional height of 0.02 mm and a cross sectional base side of 2 mm. On both ends of the heating conductor's conductor path 402, a transition conductor path 404a, 404b initially connects, before it transitions into the contacting conductor path 403a, 403b. The transition conductor paths 404a, 404b are embodied identically, they have a cross sectional height of 0.02 mm and a continuously increasing cross sectional base side, which, starting at 2 mm on the heating conductor side increases up to 6 mm on the contacting conductor path side. The contacting conductor paths 403a, 403b are embodied identically, they have a rectangular cross section comprising a cross sectional surface of 0.2 mm² with a cross sectional height of 0.02 mm and a cross sectional base side of 10 mm.

The support 401 is made of two materials A, B, which are welded or glued to one another along the dashed lines 407, 408. The material area A consists of undoped, synthetic fused silica. A good temperature reduction is provided through this in the area of the contacting conductor paths 403a, 403b. The material area B consists of a composite material comprising a matrix component in the form of fused silica. A phase of elementary silicon in the form of non-spherical areas, the percentage by weight of which is 2.5%, is distributed homogenously in the matrix. On average (median), the maximum dimensions of the silicon phase areas are in the range of between approximately 1 μm and 10 μm. The composite material is gas-tight, it has a density of 2.19 g/cm³ and it is stable in air up to a temperature of approximately 1,150° C. At high temperatures, the composite material shows a high absorption of thermal radiation and a high emissivity. The latter depends on the temperature. At 600 C.°, the normal emissivity in the wavelength range of between 2 μm and 4 μm is above 0.6. At 1,000° C., the normal emissivity in the same wavelength range is above 0.75.

1. An infrared radiator, having a support, a heating conductor's conductor path applied to the support, of an electrically conducting resistor material, as well as an electrical contacting of the heating conductor's conductor path, characterized in the support includes a composite material, which comprises an amorphous matrix component as well as an additional component in the form of a semiconductor material, and that the contacting is applied to the support as contacting conductor path, wherein the conductor cross section of the contacting conductor path is at least 3-times the conductor cross section of the heating conductor's conductor path.

2. The infrared radiator according to claim 1, characterized in that the heating conductor's conductor path and contacting conductor path are connected to one another with a substance-to-substance bond.

3. The infrared radiator according to claim 1, characterized in that the heating conductor's conductor path and the contacting conductor path are made of the same material.

4. The infrared radiator according to claim 1, characterized in that the contacting conductor path connects directly to the heating conductor's conductor path.

5. The infrared radiator according to claim 1, characterized in that a transition conductor path, the conductor cross section of which, based on the conductor cross section of the heating conductor's conductor path, increases continuously or in a plurality of stages, until the conductor cross section of the contacting conductor path is reached, is arranged between heating conductor's conductor path and contacting conductor path.

6. The infrared radiator according to claim 1, characterized in that the conductor cross section of the contacting conductor path is in the range of between 0.06 mm² and 0.2 mm², and the conductor cross section of the heating conductor's conductor path is in the range of between 0.02 mm² and 0.06 mm².

7. The infrared radiator according to claim 1, characterized in that the cross sectional height of the heating conductor's conductor path and of the contacting conductor path are in the range of between 10 μm and 25 μm.

8. The infrared radiator according to claim 1, characterized in that the support is made completely of the composite material.

9. The infrared radiator according to claim 1, characterized in that the support has a first material area made of the composite material and a second material area, which differs from the first material area in its chemical composition, wherein the heating conductor's conductor path is applied to the first material area and the contacting conductor path is applied to the second material area.

10. The infrared radiator according to claim 1, characterized in that it is designed to reach a power density above 180 kW/m², preferably to reach a power density in the range of between 180 kW/m² and 265 kW/m².
